(19) United States
(12) Patent Application Publication
(10) Pub. No.: US 2026/0362200 A1
(43) Pub. Date: Nov. 12, 2026

(54) SYNCHRONIZATION SIGNAL BURST PERIODICITY ADAPTATION

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 19/534,093

(22) Filed: Feb. 9, 2026

Related U.S. Application Data
(60) Provisional application No. 63/801,696, filed on May 7, 2025.

(51) Int. Cl. H04W 24/10; H04L 5/00

(52) U.S. Cl. CPC H04W 24/10; H04L 5/0053

(57) ABSTRACT

Various aspects of the present disclosure generally relate to wireless communication. In some aspects, a user equipment (UE) may receive, in a first slot and on a first serving cell, downlink control information identifying a change to a synchronization signal block (SSB) burst periodicity of SSB transmissions on a second serving cell. The UE may monitor, in a second slot and on the second serving cell, for an SSB transmission of the SSB transmissions with the SSB burst periodicity, wherein a location of the second slot is derived from a characteristic of the change to the SSB burst periodicity. Numerous other aspects are described.

### CROSS-REFERENCE TO RELATED APPLICATION

This Patent Application claims priority to U.S. Provisional Patent Application No. 63/801,696, filed on May 7, 2025, entitled “SYNCHRONIZATION SIGNAL BURST PERIODICITY ADAPTATION,” and assigned to the assignee hereof. The disclosure of the prior Application is considered part of and is incorporated by reference into this Patent Application.

### Field of The Disclosure

Aspects of the present disclosure generally relate to wireless communication and specifically relate to techniques, apparatuses, and methods associated with synchronization signal burst periodicity adaptation.

### Description of The Related Technology

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a synchronization signal block (SSB) is used in establishing communication between a user equipment (UE) and network nodes. SSB transmissions are used for initial access, cell reselection, and handover processes. SSB transmissions are associated with a periodicity, which refers to regular intervals at which the SSB transmissions are broadcasted. The periodicity of a set of SSB transmissions can vary, such as having intervals of 20 milliseconds, 40 milliseconds, or 80 milliseconds, among other examples.

Communication systems may use various signaling mechanisms, including downlink control information (DCI), which can instruct a UE to adapt to changes in SSB periodicity. DCI, particularly format 2_9, provides signaling information that can modify the periodicity of SSB bursts on secondary serving cells. This adaptability ensures that wireless networks can optimize signal transmission and reception based on dynamic network conditions and UE use cases. As wireless technology continues to evolve, managing SSB periodicity adaptation is an important factor in advancing network capabilities and addressing the growing demand for efficient and reliable communication solutions.

### SUMMARY

Some aspects described herein relate to a method of wireless communication performed by a user equipment (UE). The method may include receiving, in a first slot and on a first serving cell, downlink control information identifying a change to a synchronization signal block (SSB) burst periodicity of SSB transmissions on a second serving cell. The method may include monitoring, in a second slot and on the second serving cell, for an SSB transmission of the SSB transmissions with the SSB burst periodicity, wherein a location of the second slot is derived from a characteristic of the change to the SSB burst periodicity.

Some aspects described herein relate to a method of wireless communication performed by a network node. The method may include transmitting, in a first slot and on a first serving cell, downlink control information identifying a change to an SSB burst periodicity of SSB transmissions on a second serving cell. The method may include transmitting, in a second slot and on the second serving cell, an SSB transmission in an SSB burst with the SSB burst periodicity, wherein a location of the second slot is derived from a characteristic of the change to the SSB burst periodicity.

Some aspects described herein relate to a UE. The UE may include a processing system. The processing system may include one or more processors and one or more code-storing memories coupled with the one or more processors. The processing system may be configured to cause the UE to wirelessly receive, in a first slot and on a first serving cell, downlink control information identifying a change to an SSB burst periodicity of SSB transmissions on a second serving cell. The processing system may be configured to cause the UE to monitor, on a wireless link, in a second slot and on the second serving cell, for an SSB transmission of the SSB transmissions with the SSB burst periodicity, wherein a location of the second slot is derived from a characteristic of the change to the SSB burst periodicity.

Some aspects described herein relate to a network node. The network node may include a processing system. The processing system may include one or more processors and one or more code-storing memories coupled with the one or more processors. The processing system may be configured to cause the network node to wirelessly transmit, in a first slot and on a first serving cell, downlink control information identifying a change to an SSB burst periodicity of SSB transmissions on a second serving cell. The processing system may be configured to cause the network node to wirelessly transmit, in a second slot and on the second serving cell, an SSB transmission in an SSB burst with the SSB burst periodicity, wherein a location of the second slot is derived from a characteristic of the change to the SSB burst periodicity.

Some aspects described herein relate to a non-transitory computer-readable medium that stores a set of instructions for wireless communication by a UE. The set of instructions, when executed by one or more processors of the UE, may cause the UE to receive, in a first slot and on a first serving cell, downlink control information identifying a change to an SSB burst periodicity of SSB transmissions on a second serving cell. The set of instructions, when executed by one or more processors of the UE, may cause the UE to monitor, in a second slot and on the second serving cell, for an SSB transmission of the SSB transmissions with the SSB burst periodicity, wherein a location of the second slot is derived from a characteristic of the change to the SSB burst periodicity.

Some aspects described herein relate to a non-transitory computer-readable medium that stores a set of instructions for wireless communication by a network node. The set of instructions, when executed by one or more processors of the network node, may cause the network node to transmit, in a first slot and on a first serving cell, downlink control information identifying a change to an SSB burst periodicity of SSB transmissions on a second serving cell. The set of instructions, when executed by one or more processors of the network node, may cause the network node to transmit, in a second slot and on the second serving cell, an SSB transmission in an SSB burst with the SSB burst periodicity, wherein a location of the second slot is derived from a characteristic of the change to the SSB burst periodicity.

Some aspects described herein relate to an apparatus for wireless communication. The apparatus may include means for receiving, in a first slot and on a first serving cell, downlink control information identifying a change to an SSB burst periodicity of SSB transmissions on a second serving cell. The apparatus may include means for monitoring, in a second slot and on the second serving cell, for an SSB transmission of the SSB transmissions with the SSB burst periodicity, wherein a location of the second slot is derived from a characteristic of the change to the SSB burst periodicity.

Some aspects described herein relate to an apparatus for wireless communication. The apparatus may include means for transmitting, in a first slot and on a first serving cell, downlink control information identifying a change to an SSB burst periodicity of SSB transmissions on a second serving cell. The apparatus may include means for transmitting, in a second slot and on the second serving cell, an SSB transmission in an SSB burst with the SSB burst periodicity, wherein a location of the second slot is derived from a characteristic of the change to the SSB burst periodicity.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a synchronization signal (SS) hierarchy.

FIG. 3A-3E are diagrams illustrating examples associated with synchronization signal block (SSB) burst periodicity adaptation, in accordance with the present disclosure.

FIG. 4 is a diagram illustrating an example process performed, for example, at a user equipment (UE) or an apparatus of a UE.

FIG. 5 is a diagram illustrating an example process performed, for example, at a network node or an apparatus of a network node.

FIG. 6 is a diagram of an example apparatus for wireless communication.

FIG. 7 is a diagram of an example apparatus for wireless communication.

### DETAILED DESCRIPTION

In wireless communication systems, synchronization signal blocks (SSBs) are used to facilitate initial access, mobility management, and other operations for user equipment (UE). SSBs are transmitted in burst transmissions by base stations or other network nodes at periodic intervals, referred to as SSB burst periodicities. The periodicity with which SSB bursts are transmitted can vary, with shorter periodicities enabling more frequent transmission of SSB bursts and longer periodicities enabling less frequent transmission. Some examples of SSB burst periodicities include 20 milliseconds, 40 milliseconds, or 80 milliseconds, among other examples.

While adapting SSB burst periodicities provides flexibility and responsiveness to dynamic network conditions, challenges arise in determining the timing of the first SSB burst after a periodicity change. For example, when a network node instructs a UE to switch from a first SSB burst periodicity to a second burst periodicity (e.g., from 20 milliseconds to 40 milliseconds, or vice versa), the UE is to determine a timing of a first SSB burst corresponding to the new periodicity. Ambiguity in determining the timing can lead to synchronization errors, increased latency, and degraded performance in UE operations, such as mobility management and measurements. The timing may relate to a slot timing of a received DCI, a quantity of slots associated with a subcarrier spacing (SCS) of the active downlink bandwidth part (BWP), or a legacy SSB burst periodicity configuration. Additionally, the network node may configure the UE with a plurality of SSB burst periodicities, which may further result in ambiguities when switching periodicities.

Accordingly, a technical problem addressed herein involves establishing a reliable and efficient mechanism for determining a timing of SSB bursts occurring after an SSB burst periodicity change. Such a mechanism is important to reduce latency, avoid synchronization errors, or ensure seamless transitions between periodicities, among other examples, while accommodating different operational scenarios and configurations of UEs in wireless communication networks. Addressing this technical problem is important to maintaining connectivity, optimizing mobility management, or supporting efficient network operations, among other examples.

Various aspects relate generally to adapting synchronization SSB burst periodicities in wireless communication systems. Some aspects more specifically relate to a method performed by a UE in which the UE receives, in a first slot on a BWP of a first serving cell, DCI identifying a change to an SSB burst periodicity of SSB transmissions on a second serving cell. Based on the received DCI, the UE monitors, in a second slot on the second serving cell, for an SSB transmission with the new SSB burst periodicity. The location of the second slot is derived from a characteristic of the change to the SSB burst periodicity. In some aspects, the UE may identify the next SSB burst (e.g., the second slot in which the next SSB burst occurs) using the previous SSB burst periodicity. For example, the next SSB burst may occur within a common SSB burst periodicity grid, which aligns periodicities to a defined structure. The UE may determine the location of the second slot based on the common SSB burst periodicity grid, which may be derived from a smallest configured SSB periodicity. Furthermore, the timing of the DCI transmission may be constrained such that a gap between a first SSB burst of a newly indicated SSB burst periodicity and a last SSB burst of the previous SSB burst periodicity is zero or is equal to a newly indicated SSB burst periodicity, thereby avoiding irregular gaps or overlaps.

Particular aspects of the subject matter described in this disclosure can be implemented to realize one or more of the following potential advantages. By using a common grid for SSB burst periodicities, the described techniques can reduce ambiguity during transitions between periodicities. For example, switching from a longer periodicity to a shorter periodicity may be performed in alignment with the previous periodicity, ensuring predictable transitions. This approach reduces a risk of synchronization errors and irregular gaps relative to other techniques, thereby enabling consistent SSB monitoring by the UE. Additionally, the use of structured timing grids ensures that switching between periodicities occurs efficiently, reducing computational complexity associated with ambiguity in burst timing.

In some aspects, by constraining the timing of DCI transmission, the UE and the network node can further optimize processing resources during SSB periodicity adaptation. For example, the timing constraint ensures that transitions between periodicities avoid irregular gaps, reducing unnecessary computations for overlap detection or gap handling. In this way, the UE may conserve processing resources, memory resources, and/or network resources during synchronization signal monitoring and periodicity adaptation. Furthermore, efficient SSB burst monitoring in accordance with the new periodicity supports adaptation to dynamic network conditions while reducing a likelihood of wasted resource allocations for missed or improperly aligned bursts.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

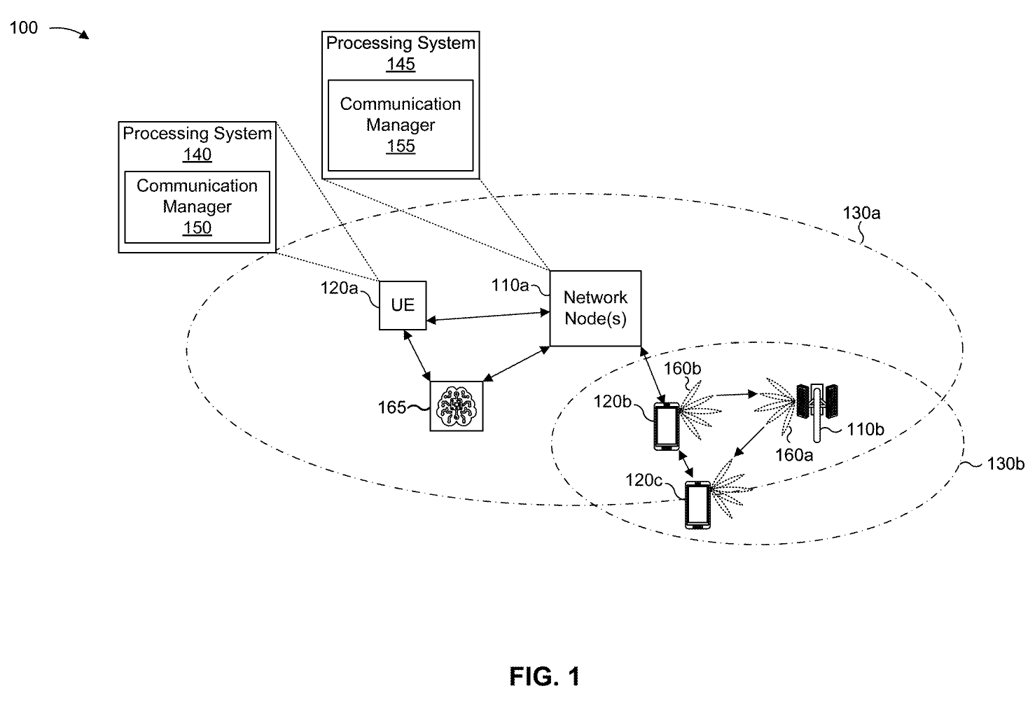

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real- time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, in a first slot and on a first serving cell, downlink control information identifying a change to an SSB burst periodicity of SSB transmissions on a second serving cell; and monitor, in a second slot and on the second serving cell, for an SSB transmission of the SSB transmissions with the SSB burst periodicity, wherein a location of the second slot is derived from a characteristic of the change to the SSB burst periodicity. Additionally, or alternatively, the communication manager 150 may perform one or more other operations described herein.

In some aspects, the network node 110 may include a communication manager 155. As described in more detail elsewhere herein, the communication manager 155 may transmit, in a first slot and on a first serving cell, downlink control information identifying a change to an SSB burst periodicity of SSB transmissions on a second serving cell; and transmit, in a second slot and on the second serving cell, an SSB transmission in an SSB burst with the SSB burst periodicity, wherein a location of the second slot is derived from a characteristic of the change to the SSB burst periodicity. Additionally, or alternatively, the communication manager 155 may perform one or more other operations described herein.

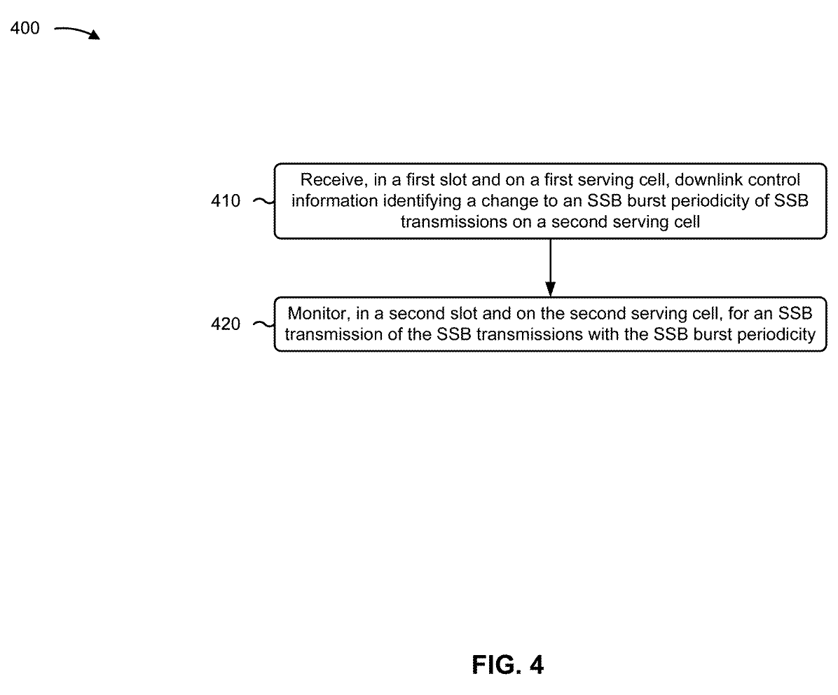

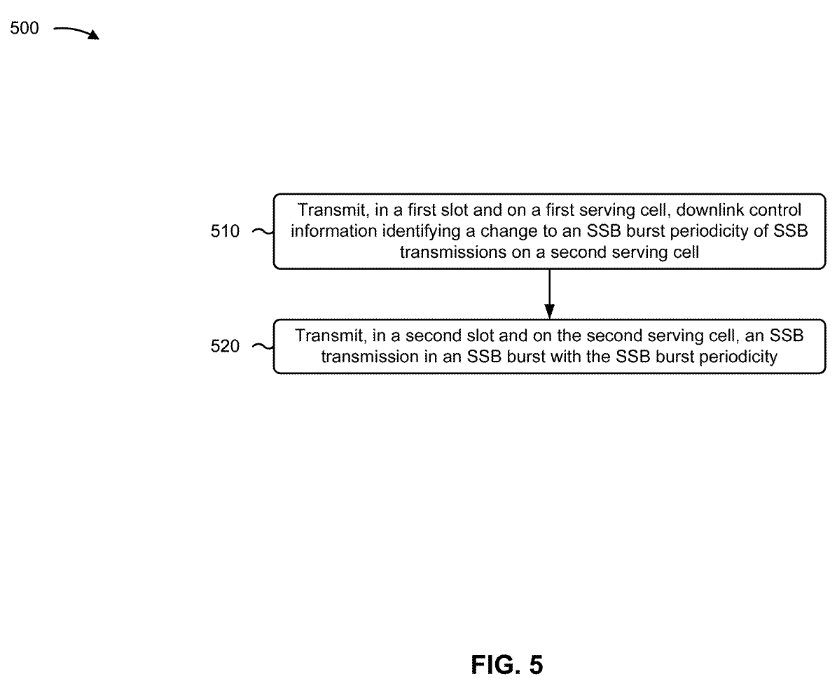

The network node 110, the processing system 145 of the network node 110, the UE 120, the processing system 140 of the UE 120, or any other component(s) of FIG. 1 may implement one or more techniques or perform one or more operations associated with SSB burst periodicity adaptation, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

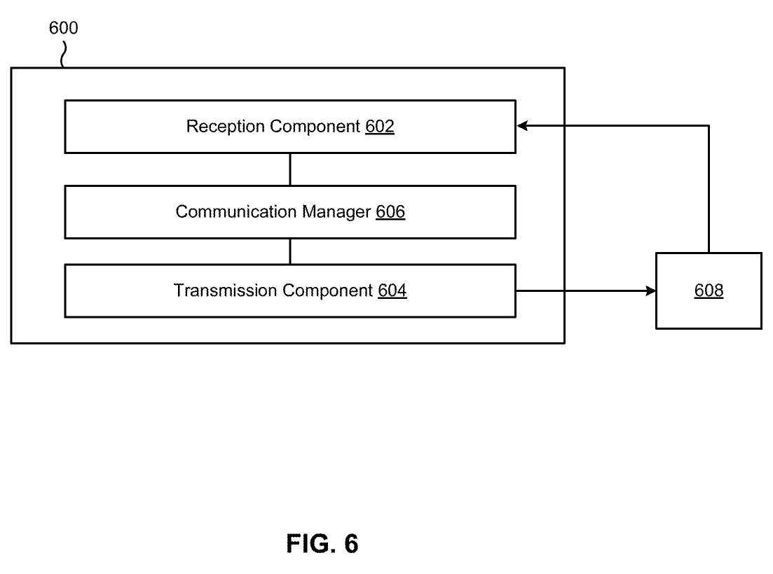

In some aspects, the UE 120 includes means for receiving, in a first slot and on a first serving cell, downlink control information identifying a change to an SSB burst periodicity of SSB transmissions on a second serving cell; or means for monitoring, in a second slot and on the second serving cell, for an SSB transmission of the SSB transmissions with the SSB burst periodicity, wherein a location of the second slot is derived from a characteristic of the change to the SSB burst periodicity. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

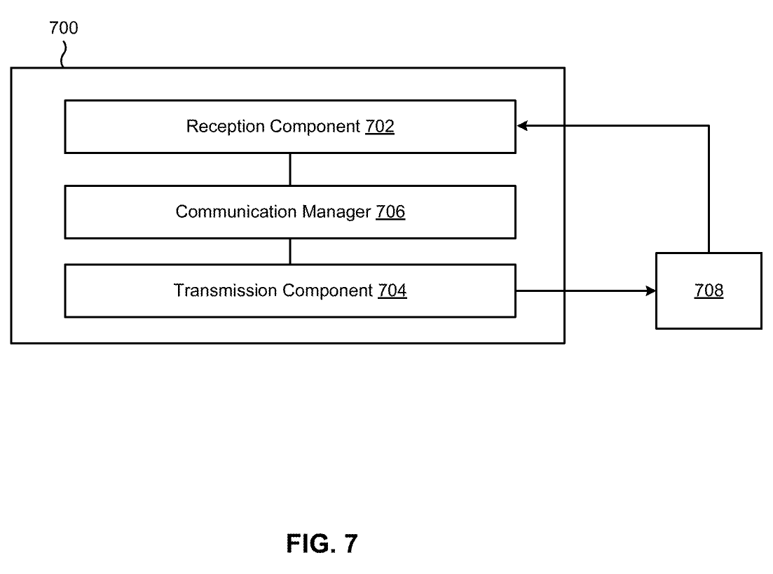

In some aspects, the network node 110 includes means for transmitting, in a first slot and on a first serving cell, downlink control information identifying a change to an SSB burst periodicity of SSB transmissions on a second serving cell; or means for transmitting, in a second slot and on the second serving cell, an SSB transmission in an SSB burst with the SSB burst periodicity, wherein a location of the second slot is derived from a characteristic of the change to the SSB burst periodicity. The means for the network node 110 to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

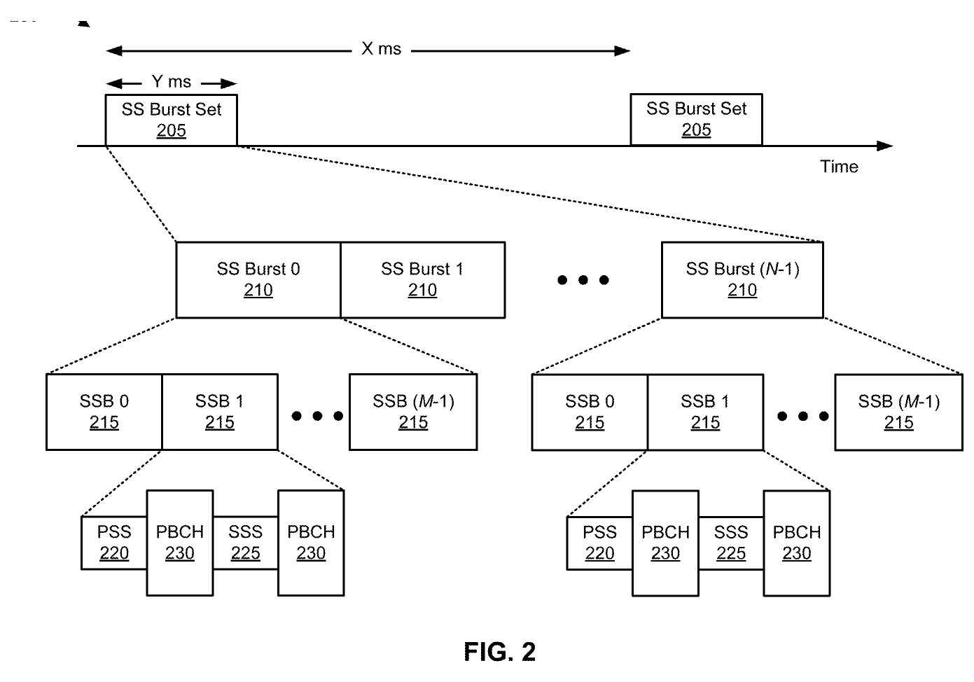

FIG. 2 is a diagram illustrating an example 200 of a synchronization signal (SS) hierarchy. As shown in FIG. 2, the SS hierarchy may include an SS burst set 205, which may include multiple SS bursts 210, shown as SS burst 0 through SS burst N-1, where N is a maximum number of repetitions of the SS burst 210 that may be transmitted by one or more network nodes. As further shown, each SS burst 210 may include one or more SS blocks (SSBs) 215, shown as SSB 0 through SSB M-1, where M is a maximum number of SSBs 215 that can be carried by an SS burst 210. In some examples, different SSBs 215 may be beam-formed differently (e.g., transmitted using different beams), and may be used for cell search, cell acquisition, beam management, or beam selection (e.g., as part of an initial network access procedure). An SS burst set 205 may be periodically transmitted by a wireless node (e.g., a network node 110), such as every X milliseconds, as shown in FIG. 2. In some examples, an SS burst set 205 may have a fixed or dynamic length, shown as Y milliseconds in FIG. 2. In some cases, an SS burst set 205 or an SS burst 210 may be referred to as a discovery reference signal (DRS) transmission window or an SSB measurement time configuration (SMTC) window.

In some examples, an SSB 215 may include resources that carry a primary synchronization signal (PSS) 220, a secondary synchronization signal (SSS) 225, or a physical broadcast channel (PBCH) 230. In some examples, multiple SSBs 215 are included in an SS burst 210 (e.g., with transmission on different beams), and the PSS 220, the SSS 225, or the PBCH 230 may be the same across each SSB 215 of the SS burst 210. In some examples, a single SSB 215 may be included in an SS burst 210. In some examples, the SSB 215 may be at least four symbols (e.g., OFDM symbols) in length, where each symbol carries one or more of the PSS 220 (e.g., occupying one symbol), the SSS 225 (e.g., occupying one symbol), or the PBCH 230 (e.g., occupying two symbols). In some examples, an SSB 215 may be referred to as an SS/PBCH block.

In some examples, the symbols of an SSB 215 are consecutive, as shown in FIG. 2. In some examples, the symbols of an SSB 215 are non-consecutive. Similarly, in some examples, one or more SSBs 215 of the SS burst 210 may be transmitted in consecutive radio resources (e.g., consecutive symbols) during one or more slots. Additionally, or alternatively, one or more SSBs 215 of the SS burst 210 may be transmitted in non-consecutive radio resources.

In some examples, the SS bursts 210 may have a burst period, and the SSBs 215 of the SS burst 210 may be transmitted by a wireless node (e.g., a network node 110) according to the burst period. In this case, the SSBs 215 may be repeated during each SS burst 210. In some examples, the SS burst set 205 may have a burst set periodicity, whereby the SS bursts 210 of the SS burst set 205 are transmitted by the wireless node according to the fixed burst set periodicity. In other words, the SS bursts 210 may be repeated during each SS burst set 205.

In some examples, an SSB 215 may include an SSB index, which may correspond to a beam used to carry the SSB 215. A UE 120 may monitor for or measure SSBs 215 using different receive (Rx) beams during an initial network access procedure or a cell search procedure, among other examples. Based at least in part on the monitoring or measuring, the UE 120 may indicate one or more SSBs 215 with a best signal parameter (e.g., a reference signal received power (RSRP) parameter) to a network node 110 (e.g., directly or via one or more other network nodes). The network node 110 and the UE 120 may use the one or more indicated SSBs 215 to select one or more beams to be used for communication between the network node 110 and the UE 120 (e.g., for a random access channel (RACH) procedure). Additionally, or alternatively, the UE 120 may use the SSB 215 or the SSB index to determine a cell timing for a cell via which the SSB 215 is received (e.g., a serving cell).

As indicated above, FIG. 2 is provided as an example. Other examples may differ from what is described with regard to FIG. 2.

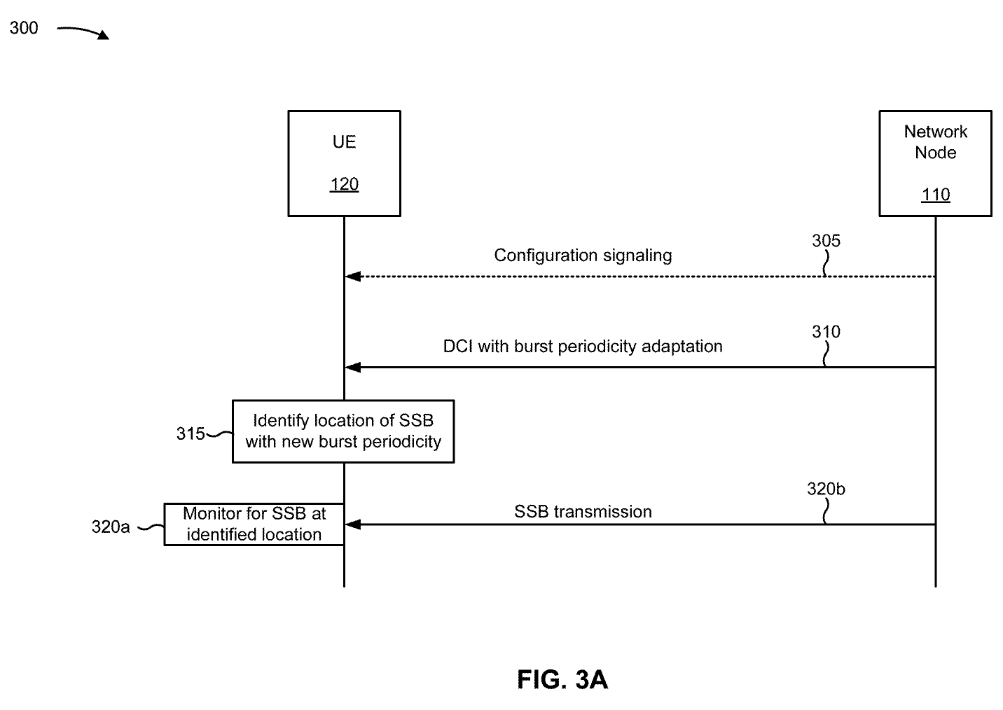

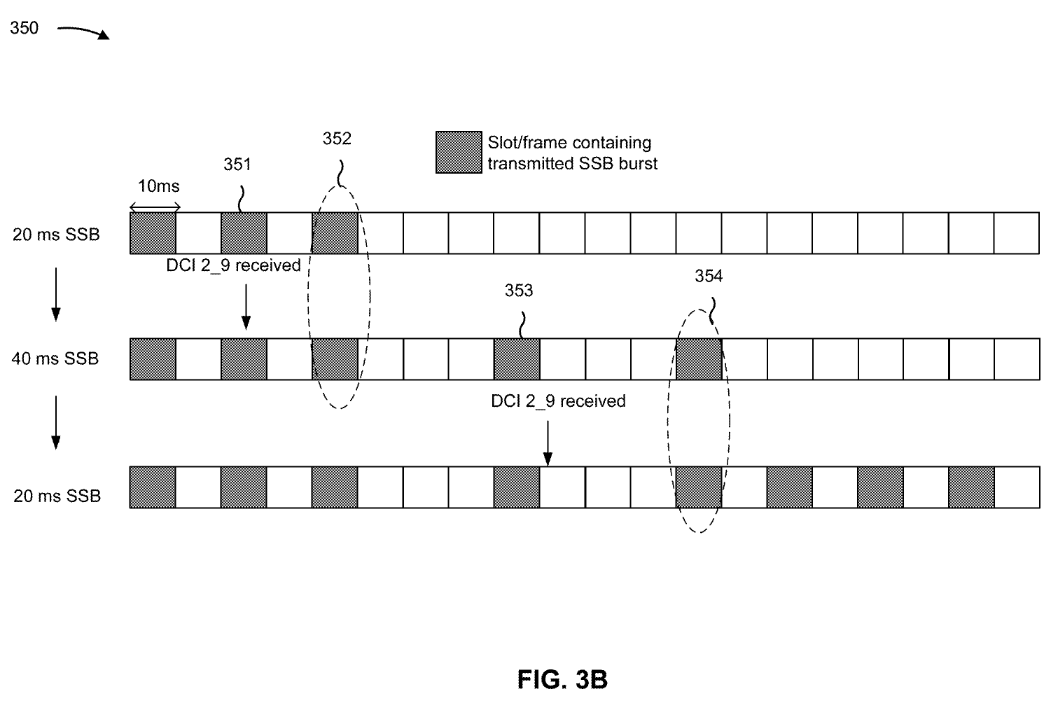

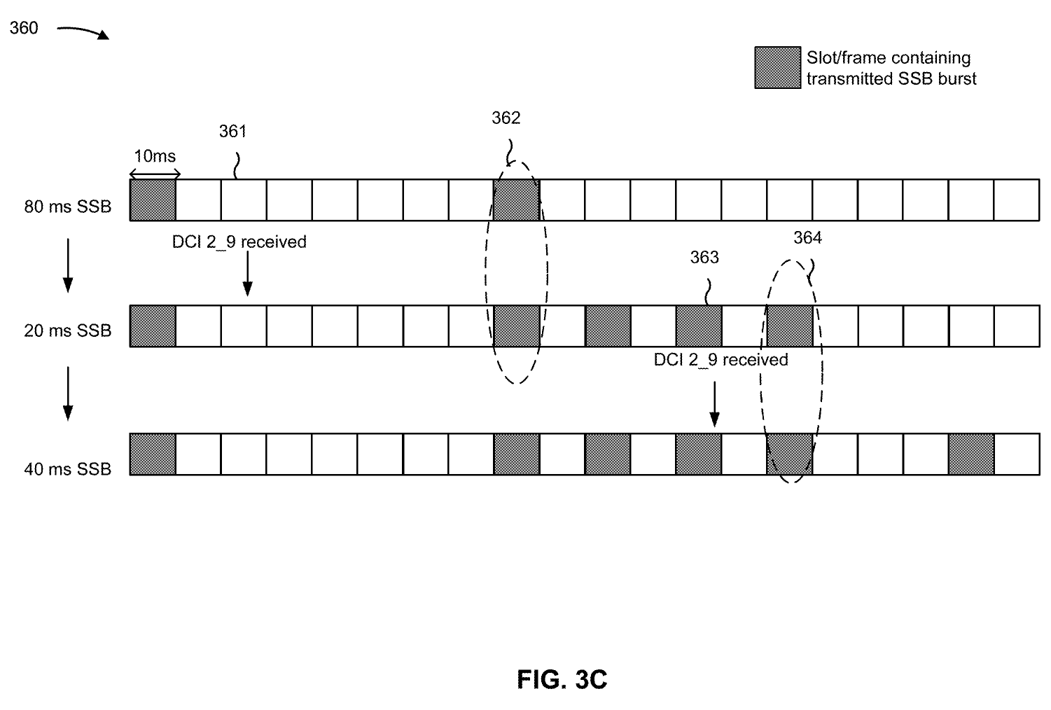

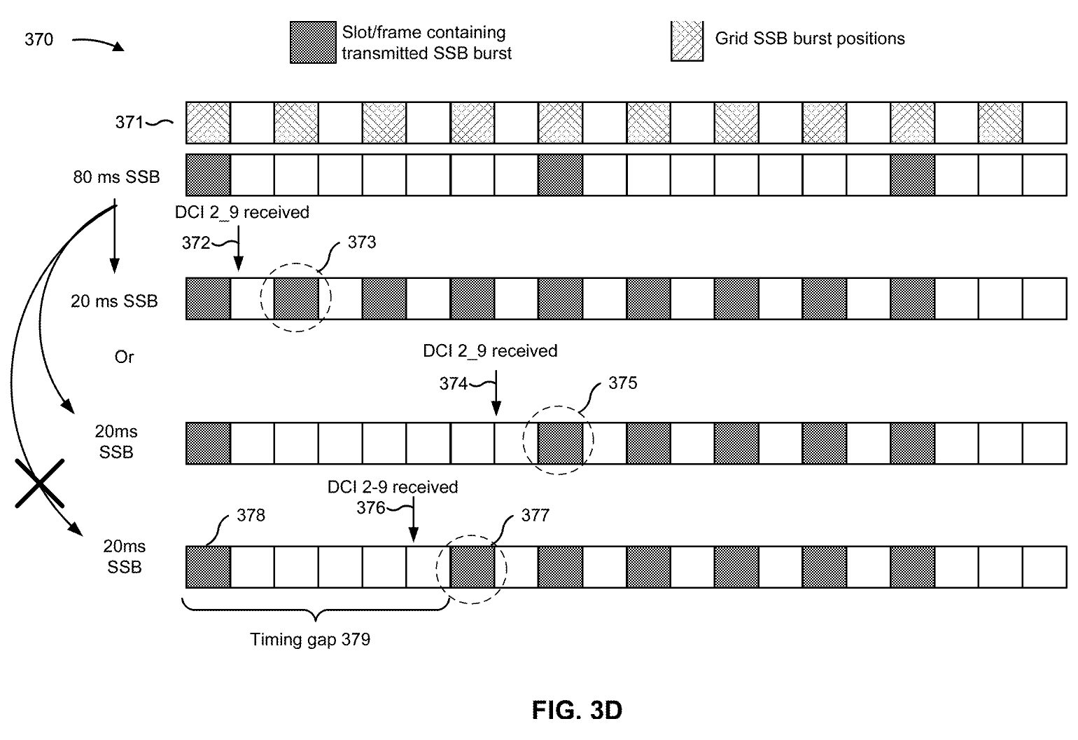

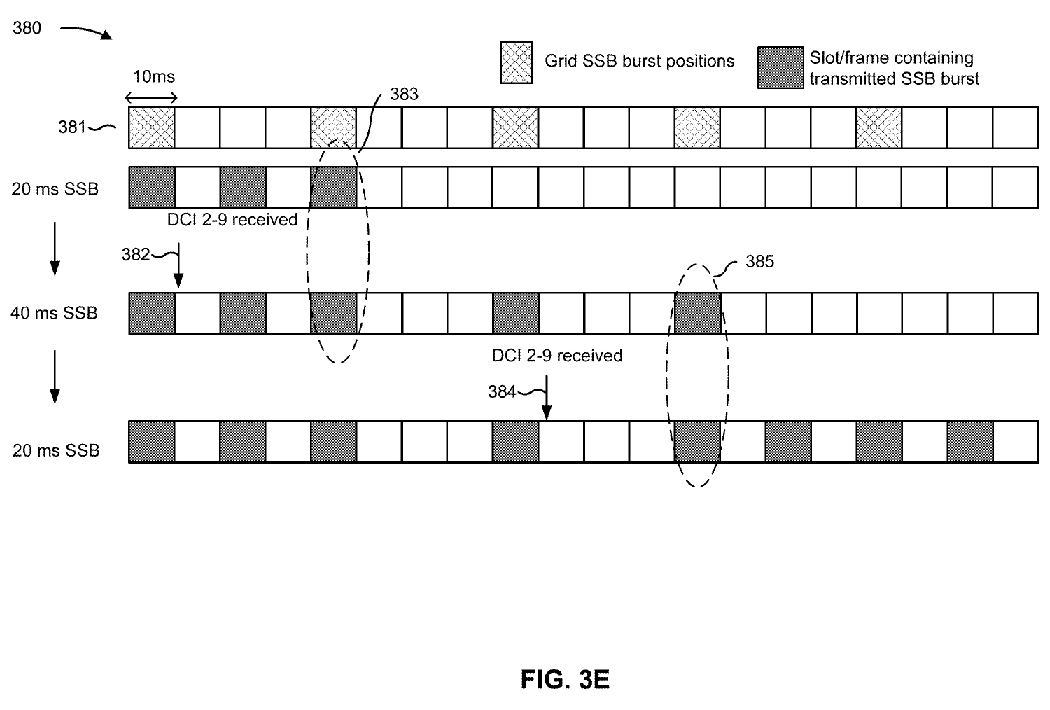

FIG. 3A-3E are diagrams illustrating examples associated with SSB burst periodicity adaptation, in accordance with the present disclosure. As shown in FIG. 3A, example 300 includes communication between a network node 110 and a UE 120.

As further shown in FIG. 3A, and by reference number 305, the network node 110 may transmit configuration signaling. For example, the network node 110 may send configuration information to the UE 120 indicating a plurality of possible SSB burst periodicities. In this way, configuration signaling may cause the UE 120 to have information that can be used for changes in SSB burst timing based on network conditions. Additionally, or alternatively, the network node 110 may transmit configuration information associated with identifying a rule for adapting between different SSB burst periodicities. For example, the network node 110 may transmit system information (SI) signaling, radio resource control (RRC) signaling, or medium access control (MAC) control element (MAC-CE) signaling associated with indicating whether to switch SSB burst periodicities based on a common grid of burst periodicities, an overlap between two SSB burst periodicities, or another factor, as described in more detail herein. Additionally, or alternatively, the network node 110 may indicate a minimum time gap for adapting an SSB burst periodicity. For example, the network node 110 may indicate that a next slot, frame, or resource in which an SSB can be received is to be at least a threshold gap (e.g., a quantity of slots, frames, or resources) after receipt of a DCI associated with triggering burst periodicity adaptation. In this case, a next grid location, in a common grid as described in more detail herein, may occur too close to receipt of a DCI, so the UE 120 may be triggered to skip the next grid location and switch SSB burst periodicities in a subsequent grid location occurring after the next grid location and at least a threshold gap after receipt of the DCI.

As further shown in FIG. 3A, and by reference number 310, the network node 110 may transmit DCI with burst periodicity adaptation. For example, the network node 110 may transmit DCI in a PDCCH resource to indicate, to the UE 120, that an SSB burst periodicity is to change from a first SSB burst periodicity to a second SSB burst periodicity. In this case, the UE 120 may determine that a new SSB burst periodicity is to become shorter or longer than a previous SSB burst periodicity. In some aspects, the UE 120 may determine that the DCI is associated with burst periodicity adaptation based on a format. For example, upon receiving DCI format 2_9, the UE 120 may adjust a monitoring schedule to accommodate a new SSB burst periodicity. Additionally, or alternatively, the network node 110 may include an explicit burst periodicity adaptation indicator, such as a bit indicator, a burst periodicity size field, or another type of indicator that the UE 120 can interpret as identifying a change to a burst periodicity.

As further shown in FIG. 3A, and by reference number 315, the UE 120 may identify a location of an SSB with the new SSB burst periodicity. For example, the UE 120 may determine when a first SSB, with the new SSB burst periodicity, is to be transmitted. In some aspects, the UE 120 may calculate a slot number in which to monitor for an SSB with the new SSB burst periodicity based on a periodicity indicated in the DCI and a timing of a last received SSB burst with a previous periodicity.

In some aspects, the UE 120 may identify a location of an SSB with the new SSB burst periodicity based on a location of an SSB with a previous SSB burst periodicity. For example, as shown in FIG. 3B, and by diagram 350, when the UE 120 is configured with an SSB burst periodicity of 20 ms, the UE 120 may receive a DCI format 2_9 in a slot 351 to trigger a transition to a new SSB burst periodicity of 40 ms. In this case, a next slot that would include an SSB with the SSB burst periodicity of 20 ms is a slot 352. Accordingly, the UE 120 receives an SSB with the new SSB burst periodicity of 40 ms in the slot 352 and starts monitoring with the new SSB burst periodicity of 40 ms. Further, the UE 120 may receive a DCI format 2_9 in or after a slot 353 to trigger a transition from a current SSB burst periodicity of 40 ms to a new SSB burst periodicity of 20 ms. Here, a next slot that would include an SSB with the current SSB burst periodicity of 40 ms is a slot 354. Accordingly, the UE 120 receives an SSB with the new SSB burst periodicity of 20 ms in the slot 354 and starts monitoring with the new SSB burst periodicity of 20 ms. Although some aspects are described herein in terms of slots, the timing may be based on other increments, such as frames, subframes, resource blocks, or another interval. For example, the slot 351 and the slot 352 may be a frame 351 and a frame 352.

As another example, as shown in FIG. 3C, and by diagram 360, when the UE 120 is configured with an SSB burst periodicity of 80 ms, the UE 120 may receive a DCI with a DCI format 2_9 in a slot 361 to trigger a transition to a new SSB burst periodicity of 20 ms. In this case, a next slot that would include an SSB with the SSB burst periodicity of 80 ms is a slot 362. Accordingly, the UE 120 receives an SSB with the new SSB burst periodicity of 20 ms in the slot 352 and starts monitoring with the new SSB burst periodicity of 20 ms. Further, the UE 120 may receive a DCI format 2_9 in a slot 363 to trigger a transition from a current SSB burst periodicity of 20 ms to a new SSB burst periodicity of 40 ms. Here, a next slot that would include an SSB with the current SSB burst periodicity of 20 ms is a slot 364. Accordingly, the UE 120 receives an SSB with the new SSB burst periodicity of 40 ms in the slot 354 and starts monitoring with the new SSB burst periodicity of 40 ms.

In some aspects, the UE 120 may determine a first SSB with a new SSB burst periodicity based on a delay or time gap after reception of the DCI. For example, the UE 120 may calculate a timing of a first possible SSB burst to occur no earlier than a configured quantity of slots after the DCI is received.

In some aspects, the UE 120 may determine a first SSB with a new SSB burst periodicity in connection with a characteristic of the change to the SSB burst periodicity. For example, the characteristic of the change to the SSB burst periodicity may include whether the change is from a longer periodicity to a shorter periodicity, or from a shorter periodicity to a longer periodicity. In other words, the UE 120 may determine a first time gap for an earliest time when a first SSB with the new SSB burst periodicity can occur when the change is from a longer periodicity to a shorter periodicity, and a second time gap when the change is from a shorter periodicity to a longer periodicity. Accordingly, the UE 120 may adjust a monitoring timing based on whether the periodicity is increasing or decreasing.

In some aspects, the UE 120 may determine a slot in which a next SSB burst is to occur, with the new SSB burst periodicity, based on a common SSB burst periodicity grid. For example, the UE 120 may be configured with or construct an SSB grid that identifies potential locations at which SSB bursts can occur with different SSB burst periodicities. In this case, as described in more detail herein, the UE 120 may identify a grid location at which the next SSB burst can occur based on the new SSB burst periodicity or the previous SSB burst periodicity (e.g., a location at which the new SSB burst periodicity can have an SSB burst, a location at which the previous SSB burst periodicity can have an SSB burst, or a location at which both the new SSB burst periodicity and the previous SSB burst periodicity can have respective SSB bursts).

In some aspects, the common grid of SSB burst periodicities may be based on the smallest configured SSB periodicity. For example, the UE 120 may be configured with or may construct a grid using a shortest possible SSB burst interval. The shortest possible SSB burst interval may be a shortest SSB burst interval with which the UE 120 is already configured or a specified shortest SSB burst interval with which the UE 120 can be configured (but is not necessarily already configured). Basing the grid on the smallest periodicity ensures consistent timing across different burst configurations.

As an example, as shown in FIG. 3D, and by diagram 370, the UE 120 may be configured with a common grid 371 based on a 20 ms periodicity. The UE 120 may receive a DCI with a DCI format 2_9 in a slot 372 to trigger a switch from a current SSB burst periodicity of 80 ms to a new SSB burst periodicity of 20 ms. Accordingly, the UE 120 may identify a next SSB burst position in the grid 371 at a slot 373, and may monitor the slot 373 to receive an SSB with a new SSB burst periodicity of 20 ms. In another example, the UE 120 may receive a DCI with a DCI format 2_9 in a slot 374 to trigger a switch from a current SSB burst periodicity of 80 ms to a new SSB burst periodicity of 20 ms. In this case, the UE 120 may identify a next SSB burst position in the grid 371 at a slot 375, and may monitor the slot 375 to receive an SSB with a new SSB burst periodicity of 20 ms.

In some aspects, a first slot location in which the DCI that conveys the SSB burst periodicity adaptation indicator can be transmitted may be such that a gap between a first SSB burst according to a newly indicated SSB burst periodicity and a last SSB burst associated with a previous SSB burst periodicity is zero or is equal to the newly indicated SSB burst periodicity. For example, the UE 120 may receive DCI in a first slot and may identify a second slot that is the same as the first slot or that is the new periodicity away from the first slot. In this way, the UE 120 and the network node 110 may ensure transitions between SSB burst periodicities without irregular timing gaps, which can prevent disruptions in burst reception. As an example, as shown in FIG. 3D, if a DCI is received in a slot 376, to trigger a first SSB burst in a next position in the common grid 371 at a slot 377, a burst periodicity between a last SSB in slot 378 and a next SSB in slot 377 is associated with an irregular timing gap 379. Accordingly, the network node 110 may avoid transmitting DCI in the slot 376 to avoid causing the irregular timing gap 379, and may restrict DCI to slots that result in a regular timing gap, such as transmitting DCI in slots 372 or 374, as described above.

In some aspects, a common grid of SSB burst periodicities is configured to include both a previous SSB burst periodicity and a new SSB burst periodicity (or all configured SSB burst periodicities). In other words, rather than determining a time to start a new SSB burst periodicity based on a smallest possible SSB burst periodicity, the UE 120 may determine a time to start a new SSB burst periodicity based on an overlap between SSB burst periodicities. As shown in FIG. 3E, and in diagram 380, the UE 120 may be configured with a grid 381 and may receive DCI in a slot 382 to trigger a switch from a 20 ms periodicity to a 40 ms periodicity. In this case, the UE 120 may identify a next slot 383 that exists at an overlap between the 20 ms periodicity and the 40 ms periodicity. Similarly, when the UE 120 receives DCI in a slot 384 to trigger a switch from the 40 ms periodicity to the 20 ms periodicity, the UE 120 identifies a next slot 385 that aligns with the grid 381.

As further shown in FIG. 3A, and by reference numbers 320a and 320b, the UE 120 may monitor for SSBs at the identified location and may receive an SSB, transmitted in an SSB burst with the new SSB burst periodicity, based on the monitoring. For example, the UE 120 may activate a receiver at a calculated time slot to detect a presence of an SSB burst. In this case, the UE 120 may receive an SSB, in an SSB burst, at a time location in which the UE 120 is monitoring for the SSB.

As indicated above, FIGS. 3A-3E are provided as examples. Other examples may differ from what is described with respect to FIGS. 3A-3E.

FIG. 4 is a diagram illustrating an example process 400 performed, for example, at a UE or an apparatus of a UE. Example process 400 is an example where the apparatus or the UE (e.g., UE 120) performs operations associated with SSB periodicity adaptation.

As shown in FIG. 4, in some aspects, process 400 may include receiving, in a first slot and on a first serving cell, downlink control information identifying a change to an SSB burst periodicity of SSB transmissions on a second serving cell (block 410). For example, the UE (e.g., using reception component 602 or communication manager 606, depicted in FIG. 6) may wirelessly receive, in a first slot and on a first serving cell, downlink control information identifying a change to an SSB burst periodicity of SSB transmissions on a second serving cell, as described above. In some aspects, the receiving the downlink control information may be performed in a similar manner to the receiving the downlink control information with burst periodicity adaptation information, as shown by reference number 310 of FIG. 3A.

As further shown in FIG. 4, in some aspects, process 400 may include monitoring, in a second slot and on the second serving cell, for an SSB transmission of the SSB transmissions with the SSB burst periodicity (block 420). For example, the UE (e.g., using communication manager 606, depicted in FIG. 6) may monitor, on a wireless link, in a second slot and on the second serving cell, for an SSB transmission of the SSB transmissions with the SSB burst periodicity, where a location of the second slot is associated with (e.g., is derived from) a characteristic of the change to the SSB burst periodicity, as described above. In some aspects, the monitoring for the SSB transmission may be performed in a similar manner to the monitoring for the SSB transmission, as shown by reference number 320a of FIG. 3A.

Process 400 may include additional aspects, such as any single aspect or any combination of aspects described below or in connection with one or more other processes described elsewhere herein.

In a first aspect, the downlink control information is associated with a downlink control information format 2_9, e.g., as described in connection with FIGS. 3A to 3E.

In a second aspect, alone or in combination with the first aspect, the characteristic of the change to the SSB burst periodicity includes whether the change is from a longer periodicity to a shorter periodicity, or from a shorter periodicity to a longer periodicity, e.g., as described in connection with FIGS. 3A to 3E.

In a third aspect, alone or in combination with one or more of the first and second aspects, process 400 includes identifying a next SSB burst associated with a previous SSB burst periodicity, and monitoring for the SSB transmission in the next SSB burst, e.g., as described in connection with FIGS. 3A to 3E.

In a fourth aspect, alone or in combination with one or more of the first through third aspects, the next SSB burst occurs within a common SSB burst periodicity grid, e.g., as described in connection with FIGS. 3A to 3E, e.g., as described in connection with FIGS. 3A to 3E.

In a fifth aspect, alone or in combination with one or more of the first through fourth aspects, the location of the second slot is based on a common grid of SSB burst periodicities, e.g., as described in connection with FIGS. 3A to 3E.

In a sixth aspect, alone or in combination with one or more of the first through fifth aspects, the common grid of SSB burst periodicities is based on the smallest configured SSB periodicity, e.g., as described in connection with FIGS. 3A to 3E.

In a seventh aspect, alone or in combination with one or more of the first through sixth aspects, the location where the downlink control information can be transmitted such that a gap between a first SSB burst according to a newly indicated SSB burst periodicity indicated in the downlink control information and a last SSB burst associated with a previous SSB burst periodicity is zero or is equal to the newly indicated SSB burst periodicity, e.g., as described in connection with FIGS. 3A to 3E.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with SSB burst periodicity adaptation.

As shown in FIG. 5, in some aspects, process 500 may include transmitting, in a first slot and on a first serving cell, downlink control information identifying a change to an SSB burst periodicity of SSB transmissions on a second serving cell (block 510). For example, the network node (e.g., using transmission component 704 or communication manager 706, depicted in FIG. 7) may wirelessly transmit, in a first slot and on a first serving cell, downlink control information identifying a change to an SSB burst periodicity of SSB transmissions on a second serving cell, as described above. In some aspects, the transmitting the downlink control information may be performed in a similar manner to the transmitting the downlink control information with burst periodicity adaptation information, as shown by reference number 310 of FIG. 3A.

As further shown in FIG. 5, in some aspects, process 500 may include transmitting, in a second slot and on the second serving cell, an SSB transmission in an SSB burst with the SSB burst periodicity (block 520). For example, the network node (e.g., using transmission component 704 or communication manager 706, depicted in FIG. 7) may wirelessly transmit, in a second slot and on the second serving cell, an SSB transmission in an SSB burst with the SSB burst periodicity, where a location of the second slot is associated with (e.g., is derived from) a characteristic of the change to the SSB burst periodicity, as described above. In some aspects, the transmitting the SSB transmission may be performed in a similar manner to the transmitting the SSB transmission, as shown by reference number 320b of FIG. 3A.

Process 500 may include additional aspects, such as any single aspect or any combination of aspects described below or in connection with one or more other processes described elsewhere herein.

In a first aspect, the downlink control information is associated with a downlink control information format 2_9, e.g., as described in connection with FIGS. 3A to 3E.

In a second aspect, alone or in combination with the first aspect, the characteristic of the change to the SSB burst periodicity includes whether the change is from a longer periodicity to a shorter periodicity, or from a shorter periodicity to a longer periodicity, e.g., as described in connection with FIGS. 3A to 3E.

In a third aspect, alone or in combination with one or more of the first and second aspects, process 500 includes identifying a next SSB burst associated with a previous SSB burst periodicity, and monitoring for the SSB transmission in the next SSB burst, e.g., as described in connection with FIGS. 3A to 3E.

In a fourth aspect, alone or in combination with one or more of the first through third aspects, the next SSB burst occurs within a common SSB burst periodicity grid, e.g., as described in connection with FIGS. 3A to 3E.

In a fifth aspect, alone or in combination with one or more of the first through fourth aspects, the location of the second slot is based on a common grid of SSB burst periodicities, e.g., as described in connection with FIGS. 3A to 3E.

In a sixth aspect, alone or in combination with one or more of the first through fifth aspects, the common grid of SSB burst periodicities is based on the smallest configured SSB periodicity, e.g., as described in connection with FIGS. 3A to 3E.

In a seventh aspect, alone or in combination with one or more of the first through sixth aspects, the location where the downlink control information can be transmitted such that a gap between a first SSB burst according to a newly indicated SSB burst periodicity indicated in the downlink control information and a last SSB burst associated with a previous SSB burst periodicity is zero or is equal to the newly indicated SSB burst periodicity, e.g., as described in connection with FIGS. 3A to 3E.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIGS. 3A-3E. Additionally, or alternatively, the apparatus 600 may be configured to perform one or more processes described herein, such as process 400 of FIG. 4. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The reception component 602 may receive, in a first slot and on a first serving cell, downlink control information identifying a change to an SSB burst periodicity of SSB transmissions on a second serving cell. The communication manager 606 may monitor, in a second slot and on the second serving cell, for an SSB transmission of the SSB transmissions with the SSB burst periodicity, wherein a location of the second slot is derived from a characteristic of the change to the SSB burst periodicity. The communication manager 606 may identify a next SSB burst associated with a previous SSB burst periodicity. The communication manager 606 may monitor for the SSB transmission in the next SSB burst.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node, or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIGS. 3A-3E. Additionally, or alternatively, the apparatus 700 may be configured to perform one or more processes described herein, such as process 500 of FIG. 5. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, in a first slot and on a first serving cell, downlink control information identifying a change to an SSB burst periodicity of SSB transmissions on a second serving cell. The transmission component 704 may transmit, in a second slot and on the second serving cell, an SSB transmission in an SSB burst with the SSB burst periodicity, wherein a location of the second slot is derived from a characteristic of the change to the SSB burst periodicity. The communication manager 706 may identify a next SSB burst associated with a previous SSB burst periodicity. The communication manager 706 may monitor for the SSB transmission in the next SSB burst.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving, in a first slot and on a first serving cell, downlink control information identifying a change to a synchronization signal block (SSB) burst periodicity of SSB transmissions on a second serving cell; and monitoring, in a second slot and on the second serving cell, for an SSB transmission of the SSB transmissions with the SSB burst periodicity, wherein a location of the second slot is derived from a characteristic of the change to the SSB burst periodicity.

Aspect 2: The method of Aspect 1, wherein the downlink control information is associated with a downlink control information format 2_9.

Aspect 3: The method of any of Aspects 1-2, wherein the characteristic of the change to the SSB burst periodicity includes whether the change is from a longer periodicity to a shorter periodicity, or from a shorter periodicity to a longer periodicity.

Aspect 4: The method of any of Aspects 1-3, further comprising: identifying a next SSB burst associated with a previous SSB burst periodicity; and monitoring for the SSB transmission in the next SSB burst.

Aspect 5: The method of Aspect 4, wherein the next SSB burst occurs within a common SSB burst periodicity grid.

Aspect 6: The method of any of Aspects 1-5, wherein the location of the second slot is based on a common grid of SSB burst periodicities.

Aspect 7: The method of Aspect 6, wherein the common grid of SSB burst periodicities is based on the smallest configured SSB periodicity.

Aspect 8: The method of any of Aspects 1-7, wherein the location where the downlink control information can be transmitted such that a gap between a first SSB burst according to a newly indicated SSB burst periodicity indicated in the downlink control information and a last SSB burst associated with a previous SSB burst periodicity is zero or is equal to the newly indicated SSB burst periodicity.

Aspect 9: A method of wireless communication performed by a network node, comprising: transmitting, in a first slot and on a first serving cell, downlink control information identifying a change to a synchronization signal block (SSB) burst periodicity of SSB transmissions on a second serving cell; and transmitting, in a second slot and on the second serving cell, an SSB transmission in an SSB burst with the SSB burst periodicity, wherein a location of the second slot is derived from a characteristic of the change to the SSB burst periodicity.

Aspect 10: The method of Aspect 9, wherein the downlink control information is associated with a downlink control information format 2_9.

Aspect 11: The method of any of Aspects 9-10, wherein the characteristic of the change to the SSB burst periodicity includes whether the change is from a longer periodicity to a shorter periodicity, or from a shorter periodicity to a longer periodicity.

Aspect 12: The method of any of Aspects 9-11, further comprising: identifying a next SSB burst associated with a previous SSB burst periodicity; and monitoring for the SSB transmission in the next SSB burst.

Aspect 13: The method of Aspect 12, wherein the next SSB burst occurs within a common SSB burst periodicity grid.

Aspect 14: The method of any of Aspects 9-13, wherein the location of the second slot is based on a common grid of SSB burst periodicities.

Aspect 15: The method of Aspect 14, wherein the common grid of SSB burst periodicities is based on the smallest configured SSB periodicity.

Aspect 16: The method of any of Aspects 9-15, wherein the location where the downlink control information can be transmitted such that a gap between a first SSB burst according to a newly indicated SSB burst periodicity indicated in the downlink control information and a last SSB burst associated with a previous SSB burst periodicity is zero or is equal to the newly indicated SSB burst periodicity.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

Aspect 24: A device comprising a processing system that includes one or more processors and one or more code-storing memories coupled with the one or more processors, the processing system configured to cause the device to perform the method of one or more of Aspects 1-16.

Aspect 25: A device comprising a processing system that includes processor circuitry and code-storing memory circuitry, the processing system configured to cause the device to perform the method of one or more of Aspects 1-16.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more antennas; and
a processing system that includes processor circuitry and memory circuitry that stores code, the processing system configured to cause the apparatus to:
wirelessly receive, in a first slot and on a first serving cell, downlink control information identifying a change to a synchronization signal block (SSB) burst periodicity of SSB transmissions on a second serving cell; and
monitor, on a wireless link, in a second slot, and on the second serving cell, for an SSB transmission of the SSB transmissions with the SSB burst periodicity, wherein a location of the second slot is derived from a characteristic of the change to the SSB burst periodicity.

2. The apparatus of claim 1, wherein the downlink control information is a downlink control information format 2_9.

3. The apparatus of claim 1, wherein the characteristic of the change to the SSB burst periodicity includes whether the change is from a longer periodicity to a shorter periodicity, or from a shorter periodicity to a longer periodicity.

4. The apparatus of claim 1, wherein the processing system is configured to cause the apparatus to:
identify a next SSB burst that has previous SSB burst periodicity; and
monitor for the SSB transmission in the next SSB burst.

5. The apparatus of claim 4, wherein the next SSB burst occurs within a common SSB burst periodicity grid.

6. The apparatus of claim 1, wherein the location of the second slot is based on a common grid of SSB burst periodicities.

7. The apparatus of claim 6, wherein the common grid of SSB burst periodicities is based on the smallest configured SSB periodicity.

8. The apparatus of claim 1, wherein the location where the downlink control information can be transmitted such that a gap between a first SSB burst according to a newly indicated SSB burst periodicity indicated in the downlink control information and a last SSB burst that has a previous SSB burst periodicity is zero or is equal to the newly indicated SSB burst periodicity.

9. An apparatus for wireless communication, comprising:
one or more antennas; and
a processing system that includes processor circuitry and memory circuitry that stores code, the processing system configured to cause the apparatus to:
wirelessly transmit, in a first slot and on a first serving cell, downlink control information identifying a change to a synchronization signal block (SSB) burst periodicity of SSB transmissions on a second serving cell; and
wirelessly transmit, in a second slot and on the second serving cell, an SSB transmission in an SSB burst with the SSB burst periodicity, wherein a location of the second slot is derived from a characteristic of the change to the SSB burst periodicity.

10. The apparatus of claim 9, wherein the downlink control information is a downlink control information format 2_9.

11. The apparatus of claim 9, wherein the characteristic of the change to the SSB burst periodicity includes whether the change is from a longer periodicity to a shorter periodicity, or from a shorter periodicity to a longer periodicity.

12. The apparatus of claim 9, wherein the processing system is configured to cause the apparatus to:
identify a next SSB burst that has a previous SSB burst periodicity; and
transmit the SSB transmission in the next SSB burst.

13. The apparatus of claim 12, wherein the next SSB burst occurs within a common SSB burst periodicity grid.

14. The apparatus of claim 9, wherein the location of the second slot is based on a common grid of SSB burst periodicities.

15. The apparatus of claim 14, wherein the common grid of SSB burst periodicities is based on the smallest configured SSB periodicity.

16. The apparatus of claim 9, wherein the location where the downlink control information can be transmitted such that a gap between a first SSB burst according to a newly indicated SSB burst periodicity indicated in the downlink control information and a last SSB burst that has a previous SSB burst periodicity is zero or is equal to the newly indicated SSB burst periodicity.

17. A method of wireless communication performed by a user equipment (UE), comprising:
receiving, in a first slot and on a first serving cell, downlink control information identifying a change to a synchronization signal block (SSB) burst periodicity of SSB transmissions on a second serving cell; and
monitoring, in a second slot and on the second serving cell, for an SSB transmission of the SSB transmissions with the SSB burst periodicity, wherein a location of the second slot is derived from a characteristic of the change to the SSB burst periodicity.

18. The method of claim 17, wherein the downlink control information is a downlink control information format 2_9.

19. The method of claim 17, wherein the characteristic of the change to the SSB burst periodicity includes whether the change is from a longer periodicity to a shorter periodicity, or from a shorter periodicity to a longer periodicity.

20. The method of claim 17, further comprising:
identifying a next SSB burst that has a previous SSB burst periodicity; and
monitoring for the SSB transmission in the next SSB burst.
